(19) United States
(12) Patent Application Publication
(10) Pub. No.: US 2026/0284758 A1
(43) Pub. Date: Sep. 24, 2026

(54) DOUBLE-SIDED CUTTING INSERT AND CUTTING TOOL INCLUDING SAME

(71) Applicant: TaeguTec Ltd., Daegu (KR)

(72) Inventor: Young Ho LEE, Daegu (KR)

(73) Assignee: TaeguTec Ltd., Daegu (KR)

(21) Appl. No.: 19/083,611

(22) Filed: Mar. 19, 2025

(51) Int. Cl. B23C 5/20

(52) U.S. Cl. CPC B23C 5/20; B23C 2200/045; B23C 2200/203; B23C 2200/369; B23C 2210/168

(57) ABSTRACT

A double-sided cutting insert and a cutting tool are provided. The cutting insert includes first and second end surfaces, a peripheral side surface, and first and second cutting edges disposed between the first and second end surfaces and the peripheral side surface, respectively. When the cutting insert is viewed from a side view, a partial cutting edge of each cutting edge includes a first circular arc portion curved convexly and a second circular arc portion curved concavely. When the cutting insert is viewed from a plan view, the second circular arc portion is disposed in a diagonal direction of the cutting insert. The peripheral side surface includes seating side surfaces disposed at an equal interval and parallel with a central axis. Each seating side surface is spaced apart from the first circular arc portion in a radially outward direction of the central axis.

### TECHNICAL FIELD

The present disclosure relates to a cutting insert for use with cutting a workpiece as well as to a cutting tool including such cutting insert.

### BACKGROUND

An end mill cutter can be used for cutting a groove or hole in a workpiece. The end mill cutter includes a plurality of cutting inserts detachably mounted to insert pockets of the cutter. The end mill cutter cuts the workpiece by means of a cutting edge provided in the cutting insert. The end mill cutter can be used to form the groove or hole in the workpiece.

The end mill cutter for use with profile milling uses a cutting insert having a cutting edge formed in a circular shape. Such cutting insert may be referred to as a round cutting insert. The round cutting insert can cut workpiece by means of the circular cutting edge such that the groove or hole of the workpiece has a full radius profile. The round cutting insert has seating surfaces disposed along a periphery of the cutting insert, wherein the seating surfaces are seated on corresponding side walls of the insert pocket.

Since the round cutting insert of a prior art technique has shape constraint due to the circular cutting edge, the seating surfaces of the round cutting insert must be positioned closer to a central axis of the cutting insert than the cutting edge and also must be disposed more inward than the cutting edge. As such, the seating surfaces of the round cutting insert of the prior art technique cannot have a large surface area, and the round cutting insert of the prior art technique cannot be stably seated on the insert pocket. Further, the round cutting insert of the prior art technique must be mounted to the insert pocket without significant inclination with respect to the rotation axis of the cutter such that the cutting trajectory of the cutting edge forms a portion of a perfect circle. Further, since the seating surfaces disposed more inward than the cutting edge are not easily visually recognized by a user, the round cutting insert of the prior art technique tends to be incorrectly mounted to the insert pocket.

### SUMMARY

Disclosed embodiments provide a cutting insert that solves at least one or more of the aforementioned problems of the prior art technique. At least one embodiment of the present disclosure provides a cutting insert that has a seating surface having a larger surface area and can be mounted to an insert pocket of a cutting tool with enhanced seating stability. At least one embodiment of the present disclosure provides a cutting insert that can cut a workpiece so that the workpiece has a full radius profile. At least one embodiment of the present disclosure provides a double-sided cutting insert having enhanced seating stability. At least one embodiment of the present disclosure provides a cutting tool that includes a double-sided cutting insert and can be used for profile milling of a workpiece.

The disclosed embodiments are directed to a double-sided cutting insert that is detachably mounted to an insert pocket of a cutting tool rotated about a rotation axis. The cutting insert according to one embodiment includes a through bore perforated in a first central axis, first and second end surfaces located opposite to each other in the first central axis, a peripheral side surface disposed between the first and second end surfaces, a first cutting edge disposed at an intersection between the first end surface and the peripheral side surface, and a second cutting edge disposed at an intersection between the second end surface and the peripheral side surface. The peripheral side surface includes a plurality of seating side surfaces configured to be seated on the insert pocket and disposed at an equal interval in a circumferential direction of the first central axis. Each of the first and second cutting edges includes a plurality of partial cutting edges connected one after another in the circumferential direction and curved convexly when the cutting insert is viewed from a plan view. Each of the plurality of partial cutting edges includes a first circular arc portion curved convexly when the cutting insert is viewed from a side view, as well as a second circular arc portion extending from the first circular arc portion and curved concavely when the cutting insert is viewed from the side view. When the cutting insert is viewed from the plan view, two second circular arc portions located opposite to each other with reference to the first central axis are disposed in a diagonal direction of the cutting insert. Each of the plurality of seating side surfaces is spaced apart from the first circular arc portion in a radially outward direction of the first central axis, and is disposed so as to be perpendicular to an imaginary line, which passes through the first central axis and a midpoint of the first circular arc portion and is orthogonal to the first central axis when the cutting insert is viewed from the side view.

In embodiments, the first and second end surfaces are configured to be seated on the insert pocket in a state of being inclined with respect to the rotation axis of the cutting tool such that the first circular arc portion and the second circular arc portion form a cutting trajectory becoming a portion of a perfect circle.

In embodiments, the peripheral side surface and the first and second cutting edges are disposed such that a first edge distance between midpoints of two first circular arc portions located opposite to each other with reference to the first central axis is shorter than a second edge distance between midpoints of two second circular arc portions located opposite to each other with reference to the first central axis.

In embodiments, each of the plurality of partial cutting edges may have a central angle of 90 degrees, 60 degrees or 45 degrees with respect to the first central axis, and the second edge distance may be 1.02 to 1.2 times, 1.01 to 1.09 times or 1.006 to 1.05 times longer than the first edge distance.

In embodiments, when the cutting insert is viewed from the plan view, the peripheral side surface forms a peripheral contour line having corners equal to the number of the plurality of seating side surfaces. The plurality of seating side surfaces form a straight line becoming a portion of the peripheral contour line.

In embodiments, two seating side surfaces neighboring in the circumferential direction among the plurality of seating side surfaces are disposed so as to form an included angle of 90 degrees, 120 degrees or 135 degrees with respect to the first central axis. The cutting insert may be configured to be rotated by 90 degrees, 60 degrees or 45 degrees so as to be remounted to the insert pocket.

In embodiments, when the cutting insert is viewed from the plan view, the peripheral side surface and the first and second cutting edges are disposed such that a diameter of a first imaginary circle inscribed in the first circular arc portion of each of the plurality of partial cutting edges is less than a diameter of a second imaginary circle inscribed in the plurality of seating side surfaces. When the cutting insert is viewed from the plan view, the first circular arc portion is curved at a first curvature, while the second circular arc portion is curved at a second curvature greater than the first curvature.

In embodiments, each of the plurality of partial cutting edges is formed such that the first curvature of the first circular arc portion is less than a curvature of the first imaginary circle and the second curvature of the second circular arc portion is greater than the curvature of the first imaginary circle. Each of the plurality of partial cutting edges may be formed such that a radius of curvature of the first circular arc portion is 1.1 to 2.5 times greater than a radius of the first imaginary circle.

In embodiments, when the cutting insert is viewed from the side view, a midpoint of the first circular arc portion and a midpoint of the second circular arc portion have a height difference measured along the first central axis. When the cutting insert is viewed from the side view, the first circular arc portion and the second circular arc portion may form a wavy shape having a width equivalent to the height difference. When the cutting insert is viewed from the plan view, the entirety of the first circular arc portion and a portion of the second circular arc portion may be formed within a sector area that is centered on the first central axis and is defined between both ends of one of the plurality of seating side surfaces.

In embodiments, the peripheral side surface includes first and second clearance side surfaces disposed between the first cutting edge and the plurality of seating side surfaces and between the second cutting edge and the plurality of seating side surfaces, respectively. The first and second clearance side surfaces are formed identically. The first clearance side surface is inclined at an obtuse angle with respect to a portion of the first end surface, and the second clearance side surface is inclined at an obtuse angle with respect to a portion of the second end surface. Each of the plurality of seating side surfaces may be divided from the first clearance side surface and the second clearance side surface by an intersection formed in a curved line.

In embodiments, the first end surface includes a seating end surface surrounding the through bore in the circumferential direction and configured to be seated on the insert pocket, and a rake end surface extending in the circumferential direction between the seating end surface and first cutting edge. The second end surface is formed identically to the first end surface.

In embodiments, the seating end surface is configured to be seated on the insert pocket in a state of being inclined at an angle of equal to or more than 15 degrees to equal to and less than 30 degrees with respect to the rotation axis of the cutting tool.

Further, the disclosed embodiments are directed to a cutting tool rotated about a rotation axis. The cutting tool according to one embodiment includes a double-sided cutting insert, a shank having a plurality of insert pockets configured such that the cutting insert is mounted thereto, and a clamp screw configured to fix the cutting insert to one of the plurality of insert pockets.

The cutting insert includes a through bore perforated in a first central axis, first and second end surfaces formed identically and located opposite to each other in the first central axis, a peripheral side surface disposed between the first and second end surfaces, and first and second cutting edges formed identically and disposed at an intersection between the first end surface and the peripheral side surface and at an intersection between the second end surface and the peripheral side surface, respectively. The peripheral side surface includes a plurality of seating side surfaces disposed at an equal interval in a circumferential direction of the first central axis. Each of the first and second cutting edges includes a plurality of partial cutting edges connected one after another in the circumferential direction and curved convexly when the cutting insert is viewed from a plan view. Each of the plurality of partial cutting edges includes a first circular arc portion curved convexly when the cutting insert is viewed from a side view, as well as a second circular arc portion extending from the first circular arc portion and curved concavely when the cutting insert is viewed from the side view. When the cutting insert is viewed from the plan view, two second circular arc portions located opposite to each other with reference to the first central axis are disposed in a diagonal direction of the cutting insert. Each of the plurality of seating side surfaces is spaced apart from the first circular arc portion in a radially outward direction of the first central axis, and is disposed so as to be perpendicular to an imaginary line, which passes through the first central axis and a midpoint of the first circular arc portion and is orthogonal to the first central axis when the cutting insert is viewed from the side view.

Each of the plurality of insert pockets includes a bottom wall positioned in the rotation direction of the cutting tool and having a threaded bore to which the clamp screw is fastened, and at least two side walls on which at least two seating side surfaces among the plurality of seating side surfaces are seated, respectively. One of the first and second end surfaces of the cutting insert is seated on the bottom wall. The bottom wall is inclined with respect to the rotation direction of the cutting tool and is contacted to one of the first and second end surfaces such that the first circular arc portion and the second circular arc portion form a cutting trajectory becoming a portion of a perfect circle. When the cutting tool is viewed from a side view, the bottom wall may be inclined at an angle of equal to and more than 15 degrees to equal to and less than 30 degrees with respect to the rotation axis of the cutting tool.

According to at least one embodiment of the present disclosure, the peripheral side surface has a plurality of seating side surfaces disposed at an equal interval with reference to the first central axis, and each seating side surface is spaced apart from the first circular arc portion of the cutting edge in the radially outward direction of the first central axis. Accordingly, the double-sided cutting insert according to one embodiment can have the seating side surfaces having a larger surface area, and can be mounted to the insert pocket of the cutting tool with enhanced seating stability.

According to at least one embodiment of the present disclosure, the first and second end surfaces are identical, the first and second cutting edges are identical, and the peripheral side surface has a plurality of seating side surfaces disposed at an equal interval. Accordingly, the double-sided cutting insert according to one embodiment can use all of the first and second cutting edges, and can be used in the state of being rotated in accordance with each seating side surface.

According to at least one embodiment of the present disclosure, the partial cutting edge of the cutting edge consists of the first circular arc portion and the second circular arc portion extending from the first circular arc portion. When the cutting insert is viewed from the side view, the first circular arc portion is curved convexly, while the second circular arc portion is curved concavely. The first circular arc portion is spaced apart from each seating side surface along the first central axis, while the second circular arc portion is disposed in the diagonal direction of the cutting insert. When the cutting insert mounted to the insert pocket cuts a workpiece, the first circular arc portion and the second circular arc portion of the partial cutting edge form a cutting trajectory becoming a portion of a perfect circle. Accordingly, the double-sided cutting insert according to one embodiment can be mounted to the insert pocket with enhanced seating stability, and can cut a workpiece partially having a full radius profile with higher productivity.

### BRIEF DESCRIPTION OF DRAWINGS

FIG. 1 is a perspective view showing a cutting tool according to one embodiment, which includes a cutting insert according to one embodiment.

FIG. 2 is a perspective view showing a cutting insert according to one embodiment.

FIG. 3 is a perspective view showing the cutting insert according to one embodiment, which is viewed in a direction different from FIG. 2.

FIG. 4 is a sectional view taken along line 4 -4 of FIG. 2.

FIG. 5 is a sectional view taken along line 5 -5 of FIG. 2.

FIG. 6 is a plan view showing the cutting insert according to one embodiment.

FIG. 7 is a side view of the cutting insert shown in FIG. 2, which is viewed from a seating side surface of a peripheral side surface.

FIG. 8 is a side view of the cutting insert shown in FIG. 2, which is viewed in a diagonal direction of the cutting insert.

FIG. 9 schematically shows a planar shape of the cutting insert shown in FIG. 6.

FIG. 10 schematically shows the cutting edge shown in FIG. 6.

FIG. 11 is a partial side view of the cutting tool shown in FIG. 1.

FIG. 12 is a bottom view of the cutting tool shown in FIG. 1.

FIG. 13 is another partial side view of the cutting tool shown in FIG. 1.

FIG. 14 is a plan view showing a cutting insert according to one embodiment.

FIG. 15 is a side view of the cutting insert shown in FIG. 14, which is viewed from a seating side surface of a peripheral side surface.

FIG. 16 is a side view of the cutting insert shown in FIG. 14, which is viewed in a diagonal direction of the cutting insert.

FIG. 17 is a plan view showing a cutting insert according to one embodiment.

FIG. 18 is a side view of the cutting insert shown in FIG. 17, which is viewed from a seating side surface of a peripheral side surface.

FIG. 19 is a side view of the cutting insert shown in FIG. 17, which is viewed in a diagonal direction of the cutting insert.

FIG. 20 is a plan view showing a cutting insert according to one embodiment.

FIG. 21 is a side view of the cutting insert shown in FIG. 20, which is viewed from a seating side surface of a peripheral side surface.

FIG. 22 is a side view of the cutting insert shown in FIG. 20, which is viewed in a diagonal direction of the cutting insert.

### DETAILED DESCRIPTION

Embodiments of the present disclosure are illustrated for the purpose of explaining the technical idea of the present disclosure. The scope of the rights according to the present disclosure is not limited to the embodiments presented below or the detailed descriptions of such embodiments.

All technical terms and scientific terms used in the present disclosure include meanings that are commonly understood by those of ordinary skill in the technical field to which the present disclosure pertains unless otherwise defined. All terms used in the present disclosure are selected for the purpose of describing the present disclosure more clearly, and are not selected to limit the scope of the rights according to the present disclosure.

Expressions such as “comprising,” “including,” “having” and the like used in the present disclosure are to be understood as open-ended terms having the possibility of encompassing other embodiments, unless otherwise mentioned in the phrase or sentence containing such expressions.

Singular expressions described in the present disclosure may encompass plural expressions unless otherwise stated, which will also apply to singular expressions recited in the claims.

Expressions such as “first,” “second,” etc. used in the present disclosure are used to distinguish a plurality of elements from one another, and are not intended to limit an order or importance of the elements.

In the present disclosure, the description that one element is “connected” or “coupled” to another element should be understood to indicate that the aforesaid one element may be directly connected or coupled to the aforesaid another element, and should be further understood that the aforesaid one element may be connected or coupled to the aforesaid another element via a new element.

Dimensional and numerical values described in the present disclosure are not limited only to the dimensional and numerical values that are described herein. Unless specified otherwise, the dimensional and numerical values may be understood to mean the described values and equivalent ranges including the values.

Hereinafter, the embodiments of the present disclosure are described with reference to the accompanying drawings. Like reference numerals in the accompanying drawings denote like or corresponding elements. Further, in the following description of the embodiments, redundant descriptions for the same or corresponding elements may be omitted. However, even if the descriptions of the elements are omitted, such elements are not intended to be excluded in any embodiment.

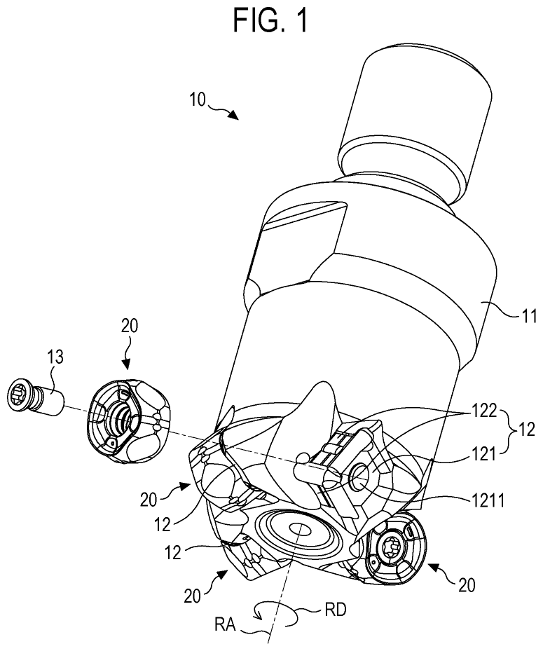

Reference is made to FIG. 1 showing a cutting tool according to one embodiment, which includes a cutting insert according to one embodiment.

The cutting tool 10 is rotated in a rotation direction RD about a rotation axis RA to cut a workpiece. The cutting tool 10 may be used in a milling process or a ramping process for cutting a groove or a hole in the workpiece. Further, the cutting tool 10 may be used in a profile milling process so as to form a corner having a full radius profile in the groove or hole of the workpiece. By way of example, the cutting tool 10 may be used as an end mill cutter or a face mill cutter.

The cutting tool 10 includes a shank 11 rotated about the rotation axis RA, a plurality of cutting inserts 20 fixed to and seated on a tip end of the shank, and a clamp screw 13 fixing the cutting insert to the shank.

The shank 11 has, at the tip end thereof, a plurality of insert pockets 12 configured to hold the cutting insert 20. Each insert pocket 12 is configured such that the cutting insert 20 is mounted to the insert pocket, wherein each insert pocket 12 includes a bottom wall 121 and a side wall 122 on which surfaces of the cutting insert 20 are seated. The clamp screw 13 is configured to fix the cutting insert to the insert pocket. The clamp screw 13 passes through the cutting insert 20 and is fastened to a threaded bore 1211 of the bottom wall 121, thereby clamping the cutting insert to the insert pocket of the shank.

The cutting insert 20 mounted and fixed to the insert pocket 12 cuts the workpiece by the rotation of the cutting tool 10. The cutting tool 10 can form a groove or hole in the workpiece as the cutting insert cuts the workpiece. According to the embodiments of the present disclosure, the cutting insert 20 seated on and fixed to the insert pocket 12 of the cutting tool 10 can form a cutting trajectory of a perfect circle.

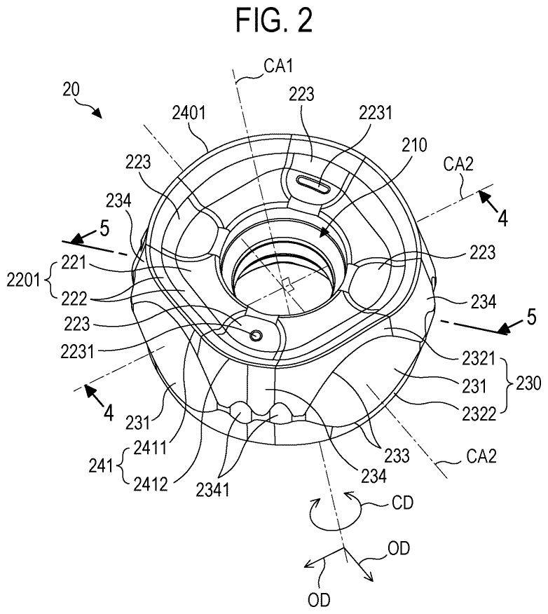

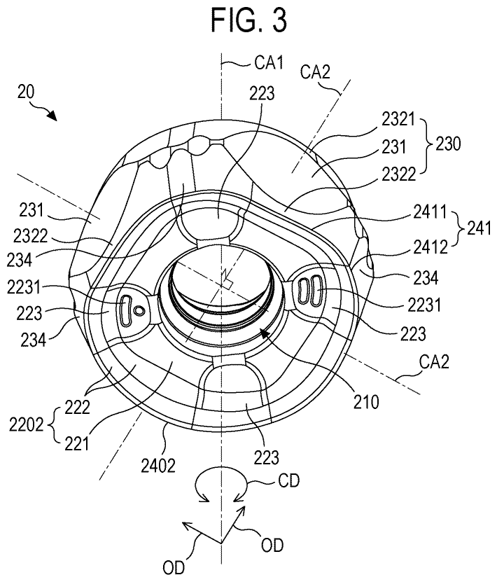

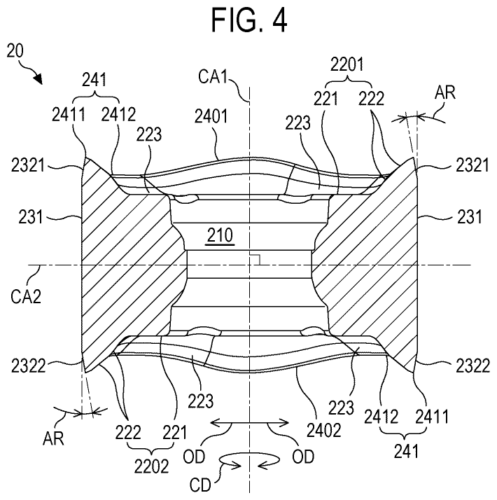

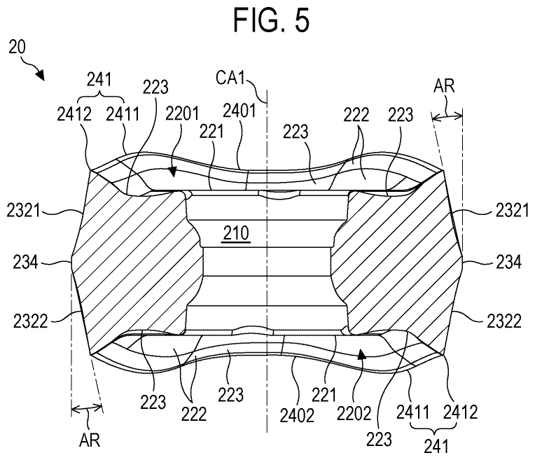

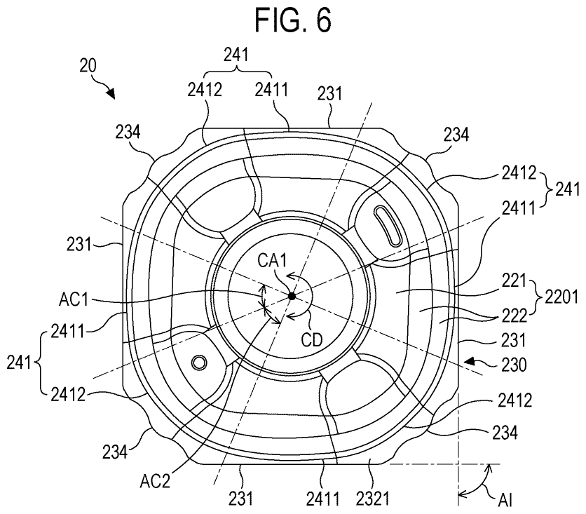

FIG. 2 is a perspective view showing a cutting insert according to one embodiment, and FIG. 3 is a perspective view showing the cutting insert according to one embodiment, which is viewed in a direction different from FIG. 2. FIG. 4 is a sectional view taken along line 4 -4 of FIG. 2, and FIG. 5 is a sectional view taken along line 5 -5 of FIG. 2. FIG. 6 is a plan view showing the cutting insert according to one embodiment. Reference is made to FIGS. 2 to 6 in the below descriptions.

The cutting insert 20 is a structure configured to be mounted to the insert pocket of the cutting tool. The cutting insert 20 is a three-dimensional structure, which has two end surfaces positioned in the rotation direction of the cutting tool and spaced apart from each other along the rotation direction of the cutting tool, and a peripheral side surface extending between the two end surfaces. The cutting insert 20 has a shape having a 180 degrees rotational symmetry with reference to an imaginary central axis. The aforesaid imaginary central axis includes a first central axis CA1 that passes through a center of the cutting insert in the plan view of the cutting insert in a thickness direction of the cutting insert. The aforesaid imaginary central axis includes a second central axis CA2 that is orthogonal to the first central axis CA1. The second central axis CA2 passes through a center of the cutting insert in a side view of the cutting insert in a width direction of the cutting insert. Further, the second central axis CA2 passes through two surfaces of the cutting insert which are located straight opposite to each other with reference to the first central axis in the plan view of the cutting insert.

The cutting insert 20 includes a through bore 210 which the clamp screw of the cutting tool passes through and is seated on. The first central axis CA1 passes through a center of a cross-sectional shape of the through bore in the thickness direction of the cutting insert, and the through bore 210 defines the first central axis CA1 of the cutting insert. The through bore 210 is perforated through the cutting insert in the first central axis CA1.

The cutting insert 20 includes a first end surface 2201 and a second end surface 2202, which are spaced apart from each other and are located opposite to each other in the first central axis CA1 (in a direction of the first central axis). According to one embodiment of the cutting insert, the first end surface 2201 and the second end surface 2202 are formed identically. The first end surface 2201 and the second end surface 2202 are spaced apart at an equal distance from the second central axis CA2 in the thickness direction of the cutting insert, respectively. Each of the first end surface 2201 and the second end surface 2202 is rotationally symmetrical by 180 degrees with reference to the first central axis CA1. The first end surface 2201 and the second end surface 2202 are rotationally symmetrical by 180 degrees with reference to the second central axis CA2. The first end surface 2201 and the second end surface 2202 are configured to be seated on the insert pocket. Specifically, the first end surface and the second end surface are contacted to and seated on the bottom wall of the insert pocket.

The cutting insert 20 includes a peripheral side surface 230 disposed between the first end surface 2201 and the second end surface 2202. The peripheral side surface 230 extends in a circumferential direction CD of the first central axis. A portion of the peripheral side surface 230 is contacted to and seated on the side wall of the insert pocket. The second central axis CA2 extends through a center of the peripheral side surface 230, and the peripheral side surface 230 is rotationally symmetrical by 180 degrees with reference to the second central axis CA2. Further, the peripheral side surface 230 is rotationally symmetrical by a predetermined angle with reference to the first central axis CA1. In the cutting insert shown in FIGS. 2 to 6, the peripheral side surface 230 is rotationally symmetrical by 90 degrees with reference to the first central axis CA1.

The cutting insert 20 includes a cutting edge for cutting the workpiece. The cutting insert 20 includes a first cutting edge 2401 disposed at an intersection of the first end surface 2201 and the peripheral side surface 230, and a second cutting edge 2402 disposed at an intersection of the second end surface 2202 and the peripheral side surface 230. Each cutting edge is formed at the entire intersection of the end surface and the peripheral side surface, and is formed so as to be continuous in the circumferential direction CD. According to one embodiment of the cutting insert, the first cutting edge and the second cutting edge are formed identically. Thus, the first cutting edge and the second cutting edge are rotationally symmetrical by 180 degrees with reference to the second central axis CA2. Further, each of the first cutting edge and the second cutting edge is rotationally symmetrical by 180 degrees with reference to the first central axis CA1, and is rotationally symmetrical by the aforesaid predetermined angle with reference to the first central axis CA1.

The cutting insert according to one embodiment includes the identical first and second end surfaces 2201 and 2202, and the identical first and second cutting edges 2401 and 2402 disposed along respective edges of the end surfaces. Accordingly, where the cutting edge disposed in one end surface approaches the end of its service life, the cutting insert may be fixed to the cutting tool such that the cutting edge disposed in the other end surface is used and aforesaid one end surface is seated on the bottom wall of the insert pocket. Since both the first cutting edge 2401 disposed at the first end surface 2201 and the second cutting edge 2402 disposed at the second end surface 2202 can be used for cutting, the cutting insert according to one embodiment is a double-sided cutting insert.

The peripheral side surface 230 of the cutting insert includes a plurality of seating side surfaces 231 configured to be seated on the insert pocket. The seating side surfaces 231 are configured to be contacted to and seated on the side wall of the insert pocket. According to the embodiments of the cutting insert, at least two seating side surfaces 231 among the plurality of seating side surfaces can be contacted to and seated on two side walls of the insert pocket, respectively.

The plurality of seating side surfaces 231 are disposed at an equal interval in the circumferential direction CA in the peripheral side surface 230, and are formed so as to have an identical shape. The peripheral side surface of the cutting insert shown in FIGS. 2 to 6 has four seating side surfaces 231.

Each of the seating side surfaces 231 may be disposed in parallel with the first central axis CA1, and includes a portion of the peripheral side surface parallel with the first central axis CA1. Each of the seating side surfaces 231 is disposed farther from the first central axis CA1 than the first cutting edge 2401 and the second cutting edge 2402. When the cutting insert is viewed in the direction of the first central axis or from the plan view, each of the seating side surfaces 231 is spaced apart from a portion of the first cutting edge 2401 (specifically, a first circular arc portion described below) and a portion of the second cutting edge 2402 (specifically, the first circular arc portion described below) in a radially outward direction OD of the first central axis CA1. Thus, the seating side surfaces 231 are located farther from the first central axis CA1 than the cutting edges, and the cutting edges are located closer to the first central axis CA1 than the seating side surfaces 231.

When the cutting insert is viewed in the direction of the first central axis or from the plan view, each end surface has a shape corresponding to a planar shape formed by the plurality of seating side surfaces 231. In the cutting insert according to one embodiment, each of the first and second end surfaces 2201 and 2202 includes a seating end surface 221 configured to be seated on the insert pocket, and a rake end surface 222 with which metallic chips created by cutting can make contact.

The seating end surface 221 surrounds the through bore 210 in the circumferential direction CD, and is configured to be contacted to and seated on the bottom wall of the insert pocket. The seating end surface 221 has a shape corresponding to the planar shape formed by the plurality of seating side surfaces 231, and has a shape of a square having round corners. Each of the first and second end surfaces 2201 and 2202 has recesses 223 equal to the number of the plurality of seating side surfaces 231. Each of the recesses 223 is formed between the through bore 210 and the cutting edge, and is positioned at the corner of the square shape of the seating end surfaces. The recess 223 allows the metallic chips created from the workpiece to flow smoothly. Two recesses 223 located opposite to each other with reference to the first central axis CA1 have an intagliated mark 2231 that allows a user to identify a corner position of the cutting insert. The intagliated marks 2231 have a shape different from each other, such as a dot shape or a bar shape.

According to one embodiment of the cutting insert, the seating end surface 221 is disposed so as to be parallel with the second central axis CA2 at an angle of 90 degrees with respect to the first central axis CA1. Further, each of the seating side surfaces 231 is disposed at an angle of 90 degrees with respect to the seating end surface 221, and is disposed so as to be orthogonal to the second central axis CA2.

The rake end surface 222 extends in the circumferential direction CD between the seating end surface 221 and the first cutting edge 2401 (or the second cutting edge). In each end surface, the rake end surface 222 forms a portion located between the cutting edge and the seating end surface.

Since the plurality of seating side surfaces are spaced apart from each cutting edge in the radially outward direction of the first central axis, the peripheral side surface includes a clearance side surface formed between the cutting edge and the plurality of seating side surfaces and inclined with respect to the first central axis. The clearance side surface reduces a friction resistance of the cutting insert against to the workpiece.

According to one embodiment of the cutting insert, each of the seating side surfaces 231 is located at the middle of the peripheral side surface 230, and the peripheral side surface 230 includes a first clearance side surface 2321 and a second clearance side surface 2322 formed identically. The first clearance side surface 2321 is disposed between the first cutting edge 2401 and the plurality of seating side surfaces 231, and extends in the circumferential direction CD. The second clearance side surface 2322 is disposed between the second cutting edge 2402 and the plurality of seating side surfaces 231, and extends in the circumferential direction CD.

The first clearance side surface 2321 is inclined at an obtuse angle with respect to a portion of the first end surface (specifically, the seating end surface 221), and the second clearance side surface 2322 is inclined at an obtuse angle with respect to a portion of the second end surface (specifically, the seating end surface 221). Further, the first clearance side surface 2321 and the second clearance side surface 2322 are inclined at a rake angle AR of an acute angle with respect to the first central axis CA1 and the second central axis CA2. By way of example, the rake angle AR may be selected within a range of more than 15 degrees to less than 30 degrees, but is not limited thereto. The obtuse angle, at which each clearance side surface is inclined with respect to the end surface, may be selected within a range of more than 90 degrees to less than 110 degrees, but is not limited thereto.

The first and second end surfaces are formed in a square shape having round corners, and the seating side surface is located at a side of such a square shape. Thus, the rake angle AR of the first and second clearance side surfaces may be minimized at the middle of the seating side surface, and may be maximized in the vicinity of ends of the seating side surface in the circumferential direction CD. Further, since the seating side surface is located at a side of the square shape having round corners and the rake angle AR of the first and second clearance side surfaces changes, one seating side surface can be divided from each clearance side surface by an intersection formed in a curved line. Specifically, the seating side surface 231 is divided from the first clearance side surface 2321 and the second clearance side surface 2322 by a pair of intersections 233 disposed with reference to the second central axis CA2. The pair of intersections 233 may be formed as a curved line concave with respect to the second central axis CA2, for example, as a parabolic line. Thus, each of the seating side surfaces 231 is divided from the first clearance side surface 2321 and the second clearance side surface 2322 by the pair of intersections 233 formed in a shape of a parabolic line.

In the peripheral side surface 230, neighboring seating side surfaces 231 are spaced apart from each other in the circumferential direction CD. Thus, the peripheral side surface 230 includes corner portions 234 that can be used as corners of the cutting insert, and the corner portion 234 is disposed between the seating side surfaces 231 neighboring in the circumferential direction CD. In the cutting insert shown in FIGS. 2 to 6, the peripheral side surface 230 includes four corner portions 234, and each of the corner portions 234 may be formed as a portion of the first and second clearance side surfaces. The peripheral side surface 230 has a pair of recesses 2341 at each of the corner portions 234. The recess 2341 of the corner portion can function to avoid interference during cutting process.

The corner portion 234 of the peripheral side surface 230 can be recognized as a reference corner of the cutting insert. Since the cutting insert is a double-sided cutting insert having the identical first and second cutting edges 2401 and 2402 and the peripheral side surface 230 has four corner portions 234, the number of the reference corners of the cutting insert may be two times the number of the seating side surfaces. Further, the cutting insert can be mounted to the insert pocket of the cutting tool at the same phases equal to the number of the reference corners.

In the cutting insert according to the embodiments of the present disclosure, each cutting edge consists of a plurality of partial cutting edges equal to the number of the plurality of seating side surfaces. Thus, as the plurality of seating side surfaces are sequentially seated on the side wall of the insert pocket, the cutting insert can be mounted to the insert pocket such that the partial cutting edges having an identical shape can be sequentially used for cutting.

Each of the first and second cutting edges 2401 and 2402 is formed so as to be continuous in the circumferential direction. Each of the first and second cutting edges 2401 and 2402 includes a plurality of partial cutting edges 241 connected one after another in the circumferential direction CD. When the cutting insert is viewed from the plan view, the plurality of partial cutting edges 241 are curved convexly, are convex outward of the cutting insert, and is concave with respect to the first central axis CA1. One partial cutting edge 241 is a portion of the first cutting edge and a portion of the second cutting edge. Thus, each of the first and second cutting edges consists of a plurality of partial cutting edges 241. In each cutting edge, the plurality of partial cutting edges 241 are disposed so as to correspond to the plurality of seating side surfaces 231 along the first central axis CA1, respectively. The number of the plurality of partial cutting edges 241 in each cutting edge equals to the number of the plurality of seating side surfaces 231. For example, the cutting insert shown in FIGS. 2 to 6 has four seating side surfaces 231, and each cutting edge has four partial cutting edges 241. By way of example, the cutting insert can be seated on the insert pocket such that each of four partial cutting edges 241 can be used in a state where the second end surface 2202 is seated on the insert pocket and the first end surface 2201 is positioned in the rotation direction of the cutting tool.

According to one embodiment of the cutting insert, each of the partial cutting edges 241 has two circular arc portions having diffident curvatures with respect to the first central axis CA1. Each of the partial cutting edges 241 includes a first circular arc portion 2411 and a second circular arc portion 2412 that are connected to each other. When the cutting insert is viewed from a plan view, the first circular arc portion 2411 is curved at a first curvature, while a second circular arc portion 2412 is curved at a second curvature. The second curvature is greater than the first curvature. Accordingly, the first circular arc portion 2411 is curved more gently than the second circular arc portion 2412, and the second circular arc portion 2412 is curved more sharply than the first circular arc portion 2411. The first circular arc portion 2411 is spaced apart from each of the seating side surfaces 231 along the first central axis CA1, and the second circular arc portion 2412 extends from the first circular arc portion 2411 in the circumferential direction CD.

Since the curvatures of the first circular arc portion 2411 and the second circular arc portion 2412 are different, each cutting edge has curvature varying throughout the entirety thereof. Where the cutting insert has four seating side surfaces, each cutting edge consisting of four partial cutting edges 241 extends in the circumferential direction CD about the first central axis CA1 in a shape alternately having four first curvatures and four second curvatures.

The plurality of seating side surfaces are disposed at an equal interval in the peripheral side surface, and are disposed more outward than the cutting edge. Thus, the cutting insert can have the seating side surfaces having a larger surface area, and can be mounted to the insert pocket of the cutting tool with enhanced seating stability. By way of example, the cutting insert according to one embodiment can exhibit seating stability similar to the seating stability of a cutting insert formed in a square or rectangular shape. Further, since the peripheral side surface includes the seating side surfaces having a larger surface area and the cutting edges are disposed more inward than the seating side surfaces, the cutting edges can be formed so as to have a longer length within an area defined by the plurality of seating side surfaces. Since the partial cutting edge of the cutting edge consists of the first and second circular arc portions having different curvatures, the cutting insert not only can have the seating side surface having a large surface area, but also can have the cutting edges having a longer length.

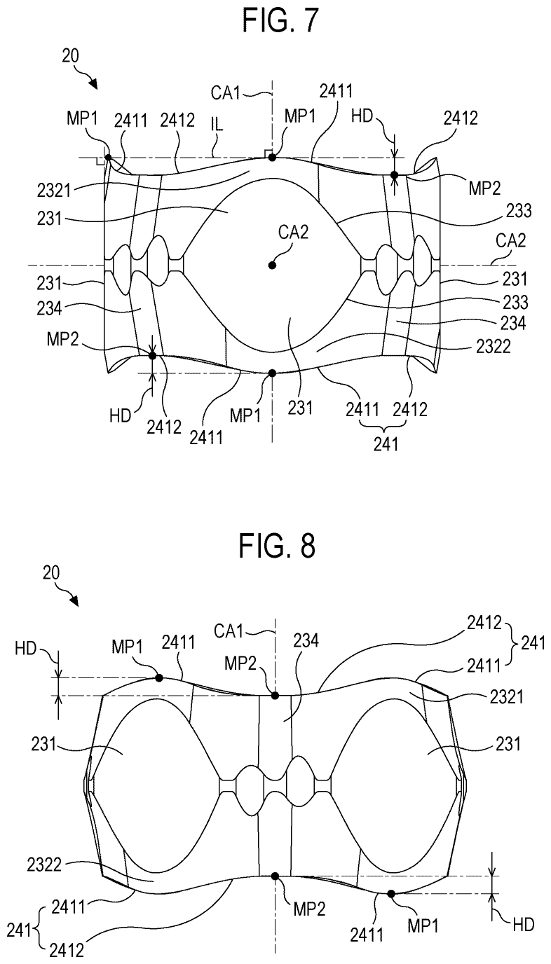

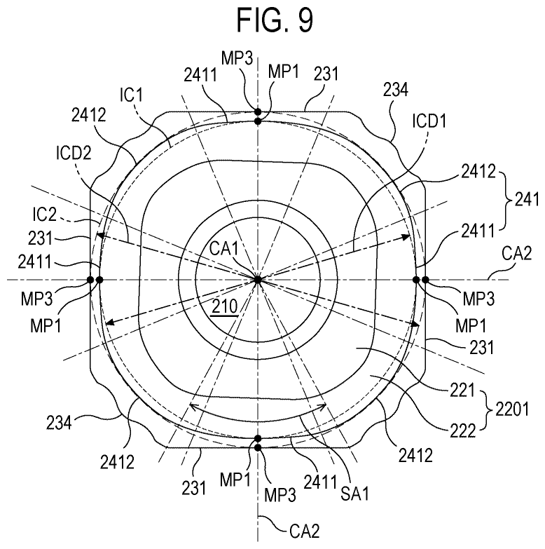

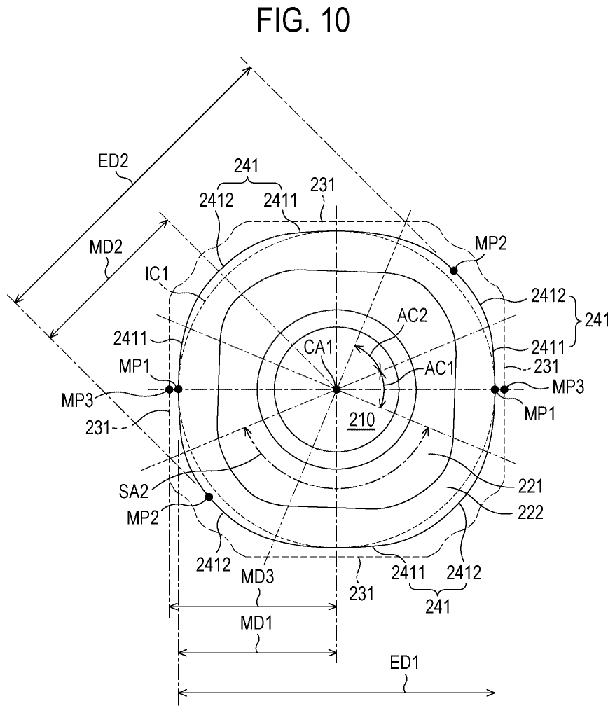

FIG. 7 is a side view of the cutting insert shown in FIG. 2, which is viewed from the seating side surface of the peripheral side surface. FIG. 8 is a side view of the cutting insert shown in FIG. 2, which is viewed in a diagonal direction of the cutting insert. FIG. 9 schematically shows a planar shape of the cutting insert shown in FIG. 6, while FIG. 10 schematically shows the cutting edge shown in FIG. 6. Reference is made to FIGS. 6 to 10 in the below descriptions.

When the cutting insert is viewed in the direction of the first central axis or from the plan view, the peripheral side surface 230 forms a square contour shape having four corners, and forms a peripheral contour line of the cutting insert. The peripheral contour line formed by the peripheral side surface 230 has a polygonal shape having corners equal to the number of the plurality of seating side surfaces 231. In the cutting insert having four seating side surfaces according to one embodiment, the peripheral contour line formed by the peripheral side surface forms the square contour shape having four corners. Each of the plurality of seating side surfaces 231 forms a straight line that becomes a portion of the peripheral contour line, and the straight line formed by the seating side surface 231 is located on a side of the square peripheral contour line.

Each seating side surface 231 is parallel with the first central axis CA1. Specifically, when the cutting insert is viewed from the side view, each seating side surface 231 is disposed so as to be perpendicular to an imaginary line IL orthogonal to the first central axis CA1, and the imaginary line IL passes through the first central axis CA1 and a midpoint MP1 of the first circular arc portion 2411. According to the embodiments of the cutting insert, the seating side surface 231 may be perpendicular to the imaginary line IL within a permissible tolerance range of +2 degrees to −2 degrees, and an angle between the seating side surface 231 and the imaginary line IL may be 90±2 degrees. When the cutting insert is viewed from the plan view, two seating side surfaces 231 neighboring in the circumferential direction CD among the plurality of seating side surfaces are disposed so as to form an included angel AI with respect to the first central axis CA1, and are rotationally symmetrical by 90 degrees with reference to the first central axis CA1. In the cutting insert having four seating side surfaces according to one embodiment, the included angel AI may be selected at 90 degrees. Each of the first end surface 2201 and the first cutting edge 2401 are rotationally symmetrical by the included angel AI with reference to the first central axis CA1.

Two partial cutting edges 241 connected to each other in the circumferential direction CA among the plurality of partial cutting edges are rotationally symmetrical by 90 degrees with reference to the first central axis CA1. Each seating side surface 231 is spaced apart from the first circular arc portion 2411 in the radially outward direction of the first central axis CA1. The second circular arc portion 2412 of the partial cutting edge is located farther than the first circular arc portion 2411 with respect to the first central axis CA1. Further, when the cutting insert is viewed from the plan view, the cutting edge is formed so that the second circular arc portions are disposed in a diagonal direction of the cutting insert with reference to the first central axis CA1. Specifically, since the peripheral side surface forms the square peripheral contour line having four corners, two second circular arc portions 2412, which are located straight opposite to each other with reference to the first central axis CA1, are disposed in the diagonal direction of the cutting insert (e.g., in a direction passing through two corner portions 234 located straight opposite to each other with reference to the first central axis).

When the cutting insert is viewed from the side view, each partial cutting edge may be formed in parallel with the second central axis. Alternatively, when the cutting insert is viewed from the side view, each partial cutting edge may be formed in a wavy shape that is concavely curved and convexly curved.

In the cutting insert according to one embodiment, when the cutting insert is viewed from the side view, each of the partial cutting edges 241 is formed in a wavy shape. The wavy partial cutting edge 241 is not contacted to the workpiece simultaneously, and can gradually cut the workpiece along the partial cutting edge. Further, the wavy partial cutting edge 241 can assist the first circular arc portion and the second circular arc portion of the partial cutting edge such that they form a cutting trajectory of a perfect circle.

When the cutting insert is viewed from the side view, the first circular arc portion 2411 of the partial cutting edge is formed so as to be curved convexly. The first circular arc portion 2411 is convex outward of the cutting insert, and is concave with respect to the second central axis CA2. The second circular arc portion 2412 of the partial cutting edge is connected to both the first circular arc portion 2411 of the partial cutting edge and the first circular arc portion 2411 of another partial cutting edge connected to the partial cutting edge. When the cutting insert is viewed from the side view, the second circular arc portion 2412 of the partial cutting edge is formed so as to be curved concavely. The second circular arc portion 2412 is concave inward of the cutting insert, and is convex with respect to the second central axis CA2.

Since the first circular arc portion 2411 and the second circular arc portion 2412 are curved in opposite directions, the midpoint MP1 of the first circular arc portion and the midpoint MP2 of the second circular arc portion are spaced apart from each other along the first central axis CA1. Further, the midpoint MP1 of the first circular arc portion and the midpoint MP2 of the second circular arc portion have a height difference HD measured along the first central axis CA1. Thus, the first circular arc portion 2411 and the second circular arc portion 2412 form a wavy shape having a width equivalent to the height difference HD. The height difference HD may be a difference between a distance measured from the second central axis CA2 to the midpoint MP1 and a distance measured from the second central axis CA2 to the midpoint MP2. By way of example, the height difference HD may be obtained by multiplying a value of one-half of a difference between the second edge distance ED2 and the first edge distance ED1 by a value of csc (15°) to csc (30°). The height difference HD may have a minimum value of 0.2 mm, and may have a suitable maximum value so as to form the wavy partial cutting edge.

When the cutting insert is viewed from the side view, the midpoint MP1 of the first circular arc portion is spaced apart from a center of the seating side surface 231 along the first central axis CA1. The midpoint MP1 of the first circular arc portion may be positioned on an imaginary straight line that passes through the center of the seating side surface and is parallel with the first central axis. The midpoint MP1 is positioned in the first circular arc portion farthest from the second central axis CA2. The midpoint MP2 of the second circular arc portion is spaced apart from a middle point between the neighboring seating side surfaces 231 along the first central axis CA1. The midpoint MP2 of the second circular arc portion may be positioned at the corner portion 234 of the peripheral side surface. The midpoint MP2 of the second circular arc portion is positioned in the second circular arc portion closest to the second central axis CA2. The partial cutting edge 241 has one midpoint MP1 and one midpoint MP2. Where the cutting insert has four seating side surfaces, each of the first cutting edge and the second cutting edge has four midpoints MP1 and four midpoints MP2.

The cutting insert has the seating side surfaces positioned more outward than the cutting edges with reference to the first central axis CA1. The seating side surface 231 and the partial cutting edge 241 are disposed such that the seating side surface is positioned more outward than the partial cutting edge with reference to the first central axis CA1. When referring to one of the plurality of seating side surfaces, the entirety of the first circular arc portion and a portion of each of two second circular arc portions may be disposed so as to correspond to one seating side surface. When the cutting insert is viewed from the plan view, a sector area SA1 that is centered on the first central axis CA1 and is defined between both ends of the seating side surface 231 may be assumed. The entirety of the first circular arc portion 2411 of one partial cutting edge and a portion of the second circular arc portion 2412 of the one partial cutting edge may be formed within the sector area SA1. Further, a portion of the second circular arc portion 2412 of another partial cutting edge connected to the one partial cutting edge may be formed within the sector area SA1. When the cutting insert is viewed from the plan view, each seating side surface 231 is not hidden by the first end surface 2201 and the first cutting edge.

Regarding the arrangement relation of the seating side surface and the cutting edge, a first imaginary circle IC1 inscribed in all of the plurality of partial cutting edges 241, and a second imaginary circle IC2 inscribed in all of the plurality of seating side surfaces 231 may be assumed. The first imaginary circle IC1 and the second imaginary circle IC2 are an imaginary circle centered on the first central axis CA1 when the cutting insert is viewed in the direction of the first central axis.

The first imaginary circle IC1 is inscribed in the respective first circular arc portions 2411 of the plurality of partial cutting edges, and has a first diameter ICD1. The first diameter ICD1 may be a minimum distance between two points of each cutting edge located opposite to each other with reference to first central axis, and may be a distance between respective midpoints MP1 of two first circular arc portions located opposite to each other with reference to the first central axis. The second imaginary circle IC2 is inscribed in midpoints MP3 of the respective seating side surfaces, and has a second diameter ICD2. The second diameter ICD2 may be a maximum width of the cutting insert measured along the second central axis CA2. The peripheral side surface and each cutting edge of the cutting insert are disposed such that the first diameter of the first imaginary circle is less than the second diameter of the second imaginary circle.

Each of the partial cutting edges 241 is formed such that the first curvature of the first circular arc portion 2411 is less than a curvature of the first imaginary circle IC1, and the second curvature of the second circular arc portion 2412 is greater than the first curvature of the first circular arc portion 2411 and the curvature of the first imaginary circle IC1. Each of the partial cutting edges 241 may be formed such that a radius of curvature of the first circular arc portion 2411 is 1.1 to 2.5 times greater than a radius of the first imaginary circle IC1. To form the cutting edge of the cutting insert according to one embodiment, the first circular arc portion 2411 is curved at a curvature less than the curvature of the first imaginary circle IC1 inscribed in the first cutting edge and the second cutting edge. In this regard, the radius of curvature of the first circular arc portion 2411 may be 1.1 times greater than the radius of the first imaginary circle IC1. Further, for the cutting insert mounted to the insert pocket to cut a workpiece while forming a cutting trajectory becoming a portion of a perfect circle, the radius of curvature of the first circular arc portion 2411 may be 2.5 times less than the radius of the first imaginary circle IC1.

Since the first imaginary circle IC1 is smaller than the second imaginary circle IC2, the plurality of seating side surfaces 231 are positioned farther from the first central axis CA1 than the first cutting edge 2401 (or the second cutting edge). Further, the first and second cutting edges consisting of the plurality of partial cutting edges 241 have a longer length in comparison with, for example, a circular cutting edge.

When the cutting insert is viewed in the direction of the first central axis or from the plan view, a distance between two points of the cutting edge located opposite to each other with reference to the first central axis CA1 may have a minimum distance and a maximum distance. The minimum distance may be a first edge distance ED1 that is measured as a distance between the midpoints MP1 of two first circular arc portions 2411 located opposite to each other with reference to the first central axis CA1. The maximum distance may be a second edge distance ED2 that is measured as a distance between the midpoints MP2 of two second circular arc portions 2412 located opposite to each other in the diagonal direction of the cutting insert with reference to the first central axis CA1. In the cutting insert according to one embodiment, the peripheral side surface and the first and second cutting edges are disposed such that the first edge distance ED1 is shorter than the second edge distance ED2. In the cutting insert according to one embodiment where the plurality of seating side surfaces form a square shape having four corners, the first and second cutting edges may be formed such that the second edge distance ED2 is 1.02 to 1.2 times longer than the first edge distance ED1.

When the cutting insert is viewed from the plan view, midpoint distances measured between the midpoint of the first circular arc portion and the first central axis, between the midpoint of the second circular arc portion and the first central axis, and between the midpoint of the seating side surface and the first central axis are different. A first midpoint distance MD1 measured between the midpoint MP1 of the first circular arc portion 2411 and the first central axis CA1 is shorter than a second midpoint distance MD2 measured between the midpoint MP2 of the second circular arc portion 2412 and the first central axis CA1. A third midpoint distance MD3 measured between the midpoint MP3 of the seating side surface 231 and the first central axis CA1 is longer than the first midpoint distance MD1. The second midpoint distance MD2 may be longer or shorter than the third midpoint distance MD3.

When the cutting insert is viewed from the plan view, each of the partial cutting edges 241 has an equal central angle with respect to the first central axis CA1. In the cutting insert according to one embodiment where the plurality of seating side surfaces form a square shape having four corners, the partial cutting edge 241 has the central angle of 90 degrees. A central angle AC1 of a sector area, which includes the first circular arc portion 2411 and is centered on the first central axis CA1, may be 45 degrees. A central angle AC2 of a sector are, which includes the second circular arc portion 2412 and is centered on the first central axis CA1, may be 45 degrees.

Since the cutting insert has the seating side surfaces disposed more outward than the cutting edge, the seating side surfaces can be formed so as to have a large surface area. Where the cutting insert is mounted to the insert pocket such that the first and second end surfaces are positioned in parallel with the rotation axis of the cutting tool, the seating side surface is contacted to a workpiece prior to the cutting edge, and thus may cause an interference between the workpiece and the cutting insert. According to the embodiments of the present disclosure, the first and second end surfaces of the cutting insert are configured to be seated on the insert pocket of the cutting tool in a state of being inclined with respect to the rotation axis of the cutting tool such that the seating side surface is not contacted to the workpiece. When the cutting insert is viewed from the plan view, the first circular arc portion 2411 and the second circular arc portion 2412 of each partial cutting edge are located more inward than each seating side surface, and do not form a portion of a perfect circle. However, since each end surface is inclined with respect to the rotation axis of the cutting tool, the first circular arc portion 2411 and the second circular arc portion 2412 can form a cutting trajectory becoming a portion of a perfect circle during cutting process. Since the first circular arc portion 2411 and the second circular arc portion 2412 form the cutting trajectory corresponding to the perfect circle, the cutting tool can cut the workpiece by precise process control.

Due to the seating side surfaces having a larger surface area, the cutting insert can be mounted to the insert pocket of the cutting insert with enhanced seating stability, and can form, in the workpiece, a shape corresponding to a portion of the perfect circle. Since the first circular arc portion 2411 and the second circular arc portion 2412 of each partial cutting edge form the cutting trajectory corresponding to a portion of the perfect circle, the cutting insert can perform a profile milling process having various shapes and various sizes. The cutting trajectory of the circular arc portions of each partial cutting edge may mean a shape or profile of a cut surface that is cut gradually by the circular arc portions during the rotation of the cutting tool. Further, the perfect circle may include a circle that has a roundness of 0.4 in a range of +0.2 to −0.2 of a target radius.

Referring to FIG. 10, each of the four areas, which are obtained by quadrisecting the cutting insert with reference to the first central axis like a Cartesian coordinate system, includes portions of neighboring two seating side surfaces, a portion of one partial cutting edge, and a portion of another partial cutting edge connected thereto. A sector area SA2 among the four areas, which includes one seating side surface positioned to face a workpiece, one partial cutting edge 241, and the second circular arc portion 2412 of another partial cutting edge (e.g., the area positioned at the third quadrant and fourth quadrant of a Cartesian coordinate system in FIG. 10), may be used for cutting a workpiece.

When the cutting insert is viewed from the plan view, one first circular arc portion 2411 and two second circular arc portions 2412 included in the sector area SA2 do not form a portion of the perfect circle. In order that the circular arc portions included in the sector area SA2 form the cutting trajectory becoming a portion of the perfect circle, or form a portion of the perfect circle when the cutting tool is viewed from a side view, each end surface of the cutting insert is positioned in a state of being inclined with respect to the rotation axis and the rotation direction of the cutting tool. That is, when the cutting tool is viewed in the rotation direction, the cutting insert is mounted to the insert pocket such that one or more partial cutting edges form a portion of the perfect circle. Accordingly, the first end surface or the second end surface seated on the insert pocket is inclined with respect to the rotation axis of the cutting tool. By way of example, the first end surface or the second end surface (specifically, the seating end surface 221 of each end surface) may be seated on the insert pocket in the state of being inclined at an angle of equal to and more than 15 degrees to equal to and less than 30 degrees with respect to the rotation axis or rotation direction of the cutting tool. Thus, when the cutting insert mounted to the insert pocket is viewed in the rotation direction of the cutting tool or from a side view of the cutting tool, one first circular arc portion 2411 and two second circular arc portions 2412 included in the sector area SA2 form a portion of the perfect circle. Accordingly, the first circular arc portion 2411 and the second circular arc portion 2412 can form the cutting trajectory becoming a portion of the perfect circle. Further, the circular arc portions of one partial cutting edge included in the sector area SA2 can form, in a corner of a hole or groove of the workpiece, a quadrant circular arc shape having a central angle of 90 degrees. In this regard, the bottom wall of the insert pocket is inclined at an acute angle with respect to the rotation direction or rotation axis of the cutting tool, thereby allowing the first circular arc portion 2411 and the second circular arc portion 2412 to form the cutting trajectory becoming a portion of the perfect circle.

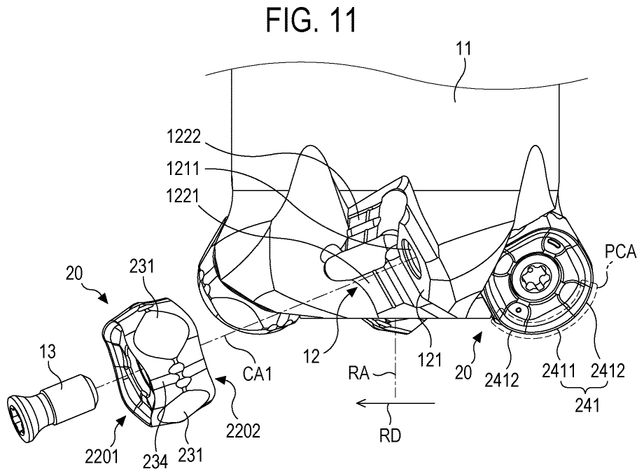

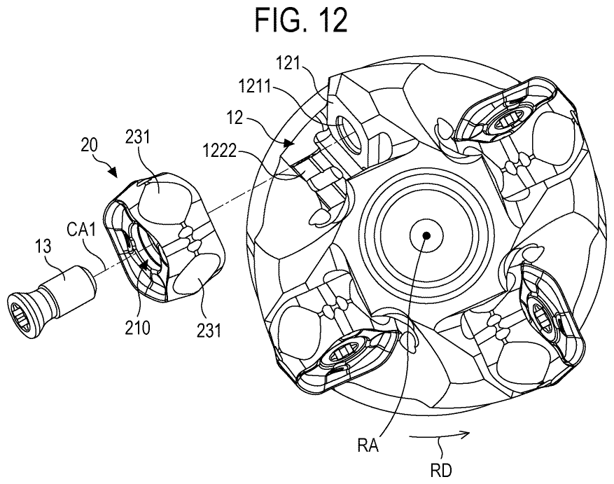

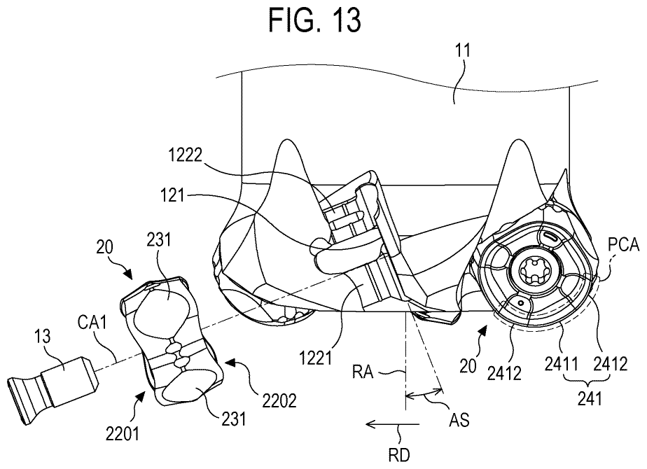

FIG. 11 is a partial side view of the cutting tool shown in FIG. 1. FIG. 12 is a bottom view of the cutting tool shown in FIG. 1, and FIG. 13 is another partial side view of the cutting tool shown in FIG. 1. Reference is made to FIGS. 11 to 13 in the below descriptions.

The bottom wall 121 of the insert pocket 12 is positioned in the rotation direction RD of the cutting tool. When the cutting insert is seated on the insert pocket, the seating end surface of the first end surface 2201 or the seating end surface of the second end surface 2202 is contacted to the bottom wall 121 and is seated on the bottom wall 121. The bottom wall 121 has a shape corresponding to the shape of the seating end surface. The threaded bore 1211, to which the clamp screw 13 is fastened, is formed in the bottom wall 121 in the first central axis CA1, for example, perpendicularly with respect to the bottom wall 121. A central axis of the threaded bore 1211 is coaxial with the first central axis CA1 of the cutting insert.

The insert pocket 12 includes a side wall, and at least two seating side surfaces 231 among the plurality of seating side surfaces of the cutting insert are contacted to and seated on the side wall. According to the embodiments of the cutting insert, the insert pocket 12 may include at least two side walls. The insert pocket 12 includes a first side wall 1221 and a second side wall 1222 that are disposed along the bottom wall 121. The first side wall 1221 and the second side wall 1222 are disposed so as to have an included angle with respect to the central axis of the threaded bore 1211 (the first central axis CA1). The included angle of the first side wall and the second side wall is equal to the above-described included angle of two seating side surfaces 231. By way of example, since the cutting insert having four seating side surfaces is mounted to the insert pocket, the included angle of the first side wall and the second side wall is 90 degrees. The first side wall 1221 and the second side wall 1222 are disposed at an angle of 90 degrees with respect to the bottom wall 121 so as to make surface contact with the seating side surface 231 parallel with the first central axis CA1.

The cutting insert 20 is mounted to the insert pocket 12 such that the first circular arc portion 2411 and the second circular arc portion 2412 form the cutting trajectory becoming a portion of the perfect circle. The cutting insert 20 is mounted to the insert pocket 12 such that the seating side surface located opposite to the seating side surface facing a workpiece is tilted in the rotation direction RD. When the cutting tool is viewed from the side view, or when the cutting tool is viewed in a direction tangent to the rotation direction, in the cutting insert 20 mounted to the insert pocket 12, the first circular arc portion 2411 and the second circular arc portion 2412 of one partial cutting edge, and the second circular arc portion 2412 of another partial cutting edge form a partial perfect circle area PCA corresponding to a partial shape of the perfect circle (see the area surrounded by a dashed line in FIG. 11). When the cutting tool is viewed from the side view, the perfect circle including the partial perfect circle area PCA may be an imaginary circle that passes through the midpoint of the first circular arc portion 2411 and is parallel with the bottom wall 121, and the perfect circle may have a center located above the first central axis CA1.

The bottom wall 121 is disposed so as to be inclined with respect to the rotation direction RD or with respect to the rotation axis RA and is contacted to the first end surface or the second end surface of the cutting insert. Thus, in the cutting insert mounted to the insert pocket, the first circular arc portion 2411 and the second circular arc portions 2412 included in the partial perfect circle area PCA are positioned to form the cutting trajectory becoming a portion of the perfect circle. For the circular arc portions of the cutting insert to form the cutting trajectory becoming a portion of the perfect circle, the bottom wall 121 is inclined at a predetermined seating angle with respect to the rotation axis RA of the cutting tool. When the cutting tool is viewed from the side view as shown in FIG. 13, the bottom wall 121 is inclined at a seating angle AS with respect to the rotation axis RA. The seating angle SA may be in a range of equal to and more than 15 degrees to equal to and less than 30 degrees with respect to the rotation axis RA. According to the embodiments of the cutting insert, the seating angle AS of the bottom wall 121 may be selected within the above-described range.

The circular arc portions included in the partial perfect circle area PCA can be used with various combinations when the cutting tool forms a hole or groove in a workpiece. When the cutting tool starts to form the hole or groove in the workpiece, the second circular arc portion 2412 located inward in the partial perfect circle area PCA can be used. When the cutting tool moves toward a wall surface of the hole of groove to cut the wall surface, the first circular arc portion 2411 and the second circular arc portion 2412 of one partial cutting edge in the partial perfect circle area PCA can be used. When the cutting tool cuts a bottom surface of the hole or groove, one first circular arc portion 2411 and two second circular arc portions 2412 in the partial perfect circle area PCA can be used. In such a case, one first circular arc portion 2411 and two second circular arc portions 2412 are involved in cutting process, and can form the cutting trajectory corresponding to a portion of the perfect circle having a roundness of 0.4. Further, one partial cutting edge 241 can form, in a corner of the hole or groove, the quadrant circular arc shape.

The cutting insert is mounted to the insert pocket so as to form the cutting trajectory of the perfect circle. The cutting insert has the cutting edges disposed more inward than the seating side surfaces, and the seating side surfaces disposed more outward than the cutting edges. Accordingly, the cutting insert can be designed so that an imaginary circle inscribed in the partial cutting edges can have a smaller diameter. Accordingly, the cutting tool can be designed so as to include more cutting inserts while maintaining stiffness, and can contribute to productivity improvement.

Where a portion of the first cutting edge or a portion of the second cutting edge approaches the end of a service life, the cutting insert 20 can be remounted to the insert pocket 12 of the cutting tool to use an unused portion of the cutting edge for cutting process. In this regard, the cutting insert is configured to be rotated by an angle obtained by dividing 360 degrees by the number of the plurality of seating side surfaces 231, and to be remounted to the insert pocket 12 of the cutting tool. The cutting insert is rotated by the number of the corner portions 234 of the peripheral side surfaces and can be remounted to the insert pocket 12. The cutting insert having four seating side surfaces is rotated by 90 degrees and can be remounted to the insert pocket. The cutting insert having four seating side surfaces can be remounted to the insert pocket in accordance with each of the four corner portions with regard to the first end surface, and can be also remounted to the insert pocket in accordance with each of four corner portions with regard to the second end surface.

Since each of the seating side surfaces is located more outward than the cutting edges, a user can visually recognize the seating side surfaces of the cutting insert, and can mount the cutting insert to the insert pocket at a correct position. For example, where the user misunderstands the mounting direction of the cutting insert and brings the corner portion between the neighboring seating side surfaces into contact with the side wall of the insert pocket, the through bore of the cutting insert and the threaded bore 1211 of the bottom wall are not aligned along the first central axis CA1, but are offset from each other at a considerable distance. Therefore, the clamp screw cannot be fastened to the threaded bore 1211 through the through bore of the cutting insert. The user can fasten the clamp screw to the threaded bore 1211 through the through bore only in a state where the seating side surface is contacted to and seated on the side wall corresponding thereto. Accordingly, the cutting insert can prevent incorrect mounting to the insert pocket, and can be used user-friendly.

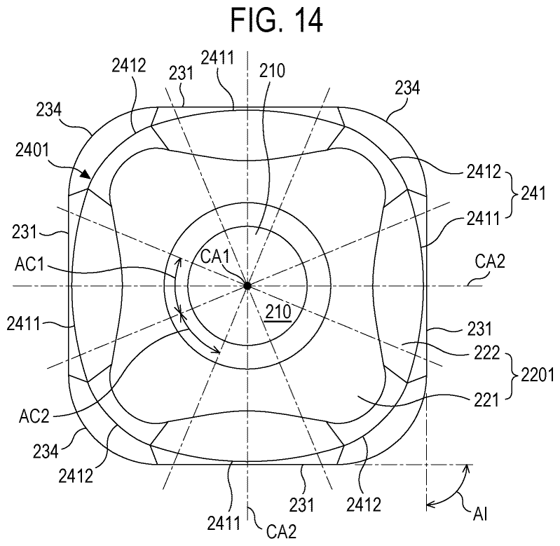

FIGS. 14 to 22 show various embodiments of the cutting insert of the present disclosure. The cutting inserts shown in FIGS. 14 to 22 include the identical first and second end surfaces and the identical first and second cutting edges, like the cutting insert according to the foregoing embodiments.

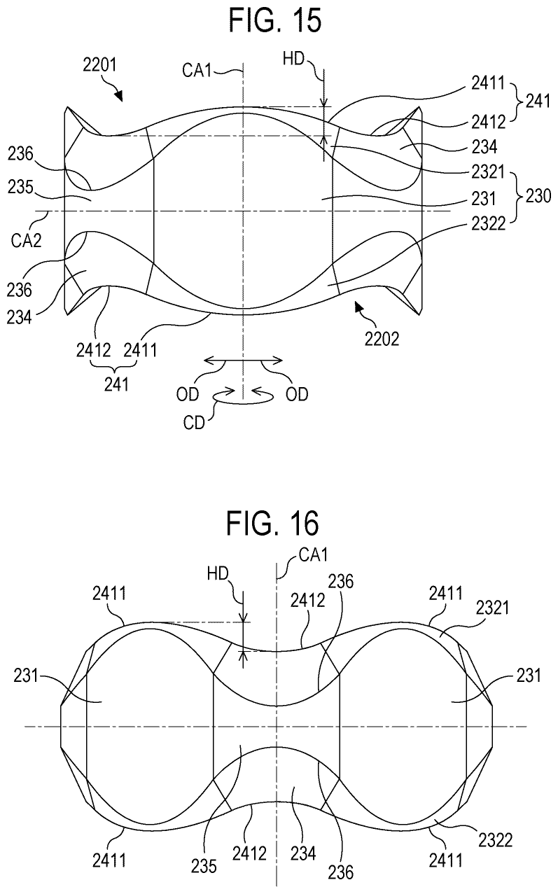

Reference is made to FIGS. 14 to 16. FIG. 14 is a plan view showing a cutting insert according to one embodiment. FIG. 15 is a side view of the cutting insert shown in FIG. 14, which is viewed from a seating side surface of a peripheral side surface. FIG. 16 is a side view of the cutting insert shown in FIG. 14, which is viewed in a diagonal direction of the cutting insert. The cutting insert shown in FIGS. 14 to 16 is configured similarly to the cutting insert according to the foregoing embodiments.

When the cutting insert is viewed from the plan view, the cutting insert forms a square contour shape. The peripheral side surface 230 forms a square peripheral contour line having four round corners, and includes four seating side surfaces 231. In the peripheral side surface 230, each of the seating side surfaces is spaced apart from the first circular arc portion 2411 of the first cutting edge 2401 (or the second cutting edge) in the radially outward direction OD of the first central axis CA1. The seating side surfaces 231 neighboring in the circumferential direction CD are disposed so as to form the included angel AI of 90 degrees with respect to the first central axis CA1.

In the peripheral side surface 230, the neighboring seating side surfaces 231 are connected by a connecting side surface 235. The connecting side surface 235 is located at the corner portion 234 of the peripheral side surface and is parallel with the first central axis CA1. The connecting side surface 235 is divided from the first clearance side surface 2321 and the second clearance side surface 2322 by an intersection 236 formed in a curved line. The intersection 236 is connected to the intersection between the seating side surface and the clearance side surface. In the partial cutting edge 241 of each cutting edge, the first circular arc portion 2411 is spaced apart from the seating side surface 231 along the first central axis CA1, and the second circular arc portion 2412 is spaced apart from the connecting side surface 235 along the first central axis CA1. The central angle AC1 of the sector area including the first circular arc portion 2411, and the central angle AC2 of the sector area including the second circular arc portion 2412 may be 45 degrees. When the cutting insert is viewed from the side view, the first circular arc portion 2411 is formed so as to be curved convexly, and the second circular arc portion 2412 is formed so as to be curved concavely. In each partial cutting edge formed in a wavy shape, the first circular arc portion 2411 and the second circular arc portion 2412 have the height difference HD along the first central axis CA1. Two second circular arc portions 2412 located opposite to each other with reference to the first central axis CA1 are disposed in the diagonal direction of the cutting insert (e.g., a direction passing through two corners located straight opposite to each other with reference to the first central axis in the square contour shape).

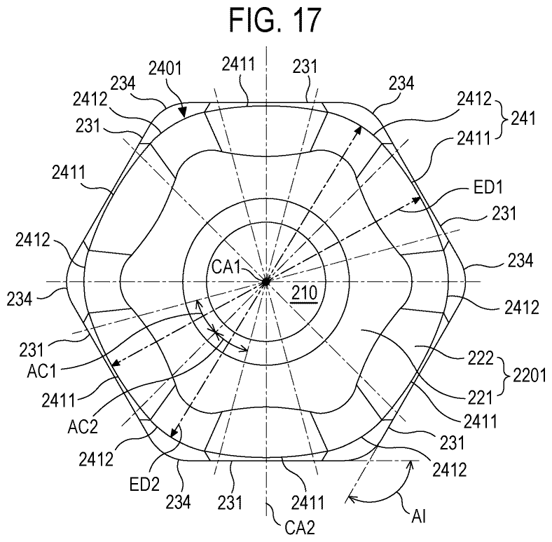

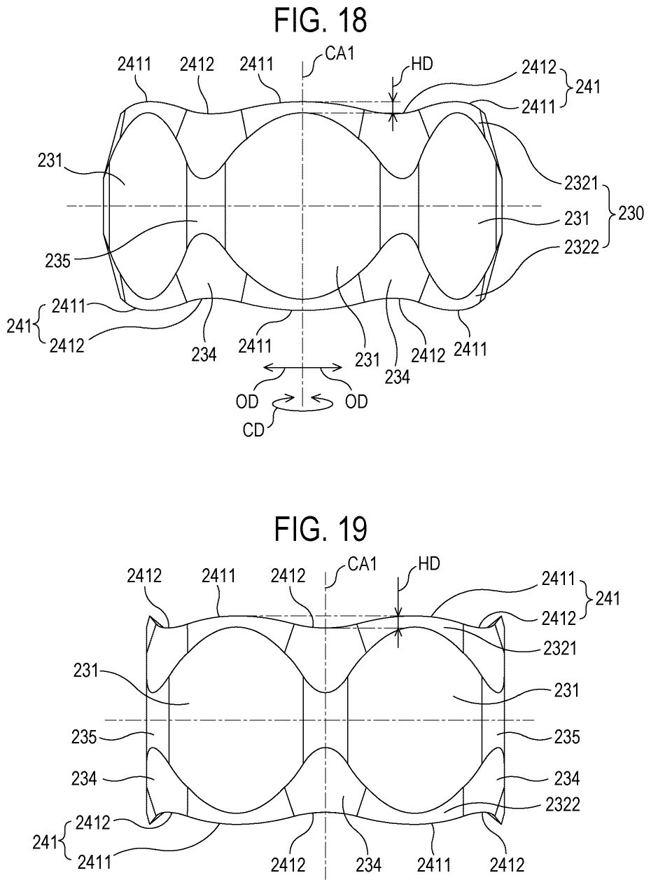

Reference is made to FIGS. 17 to 19. FIG. 17 is a plan view showing a cutting insert according to one embodiment. FIG. 18 is a side view of the cutting insert shown in FIG. 17, which is viewed from a seating side surface of a peripheral side surface. FIG. 19 is a side view of the cutting insert shown in FIG. 17, which is viewed in a diagonal direction of the cutting insert.

When the cutting insert is viewed from the plan view, the cutting insert forms a regular hexagonal contour shape. The peripheral side surface 230 forms a regular hexagonal peripheral contour line having six round corners. The peripheral side surface 230 includes six seating side surfaces 231, and each of the seating side surfaces is spaced apart from the first circular arc portion 2411 of the first cutting edge 2401 (or the second cutting edge) in the radially outward direction OD of the first central axis CA1. The seating side surfaces 231 neighboring in the circumferential direction CD are disposed so as to form the included angel AI of 120 degrees with respect to the first central axis CA1. The peripheral side surface 230 includes six seating side surfaces and six corner portions 234, thereby providing twelve reference corners to the cutting insert.

Each of the first cutting edge 2401 and the second cutting edge includes six partial cutting edges 241. Each of the partial cutting edges 241 has the central angle of 60 degrees with respect to the first central axis CA1. The central angle AC1 of the sector area including the first circular arc portion 2411, and the central angle AC2 of the sector area including the second circular arc portion 2412 may be 30 degrees. When the cutting insert is viewed from the side view, the first circular arc portion 2411 is formed so as to be curved convexly, and the second circular arc portion 2412 is formed so as to be curved concavely. In each partial cutting edge formed in a wavy shape, the first circular arc portion 2411 and the second circular arc portion 2412 have the height difference HD along the first central axis CA1.

The first diameter of the first imaginary circle inscribed in the first circular arc portions is less than the second diameter of the second imaginary circle inscribed in the seating side surfaces. The first curvature of the first circular arc portion 2411 is greater than the first curvature of the first circular arc portion shown in FIG. 14, and the second curvature of the second circular arc portion 2412 is greater than the second curvature of the second circular arc portion shown in FIG. 14. The edge distance ED1 between the midpoints of two first circular arc portions 2411 located opposite to each other with reference to the first central axis CA1 is shorter than the second edge distance ED2 between the midpoints of two second circular arc portions 2412 located opposite to each other with reference to the first central axis CA1. By way of example, the second edge distance ED2 may be 1.01 to 1.09 times longer than the first edge distance ED1. The second circular arc portions 2412 located opposite to each other with reference to the first central axis CA1 are disposed in the diagonal direction of the cutting insert (e.g., a direction passing through two corners located straight opposite to each other with reference to the first central axis in the regular hexagonal contour shape).

The cutting insert is rotated by 60 degrees and can be remounted to the insert pocket of the cutting tool. The insert pocket of the cutting tool, which holds the cutting insert shown in FIG. 17, may include two or more side walls, which two or more seating side surfaces 231 are contacted to and seated on, respectively. Further, the bottom wall of the insert pocket is inclined with respect to the rotation axis of the cutting tool at a seating angle less than the seating angle of the bottom wall of the insert pocket holding the cutting insert shown in FIG. 14.

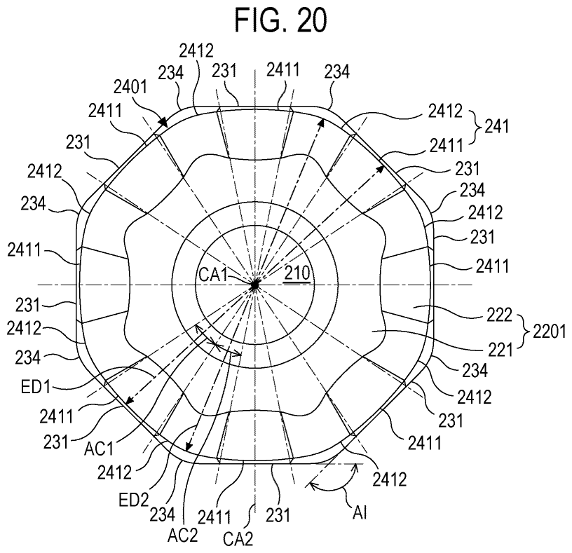

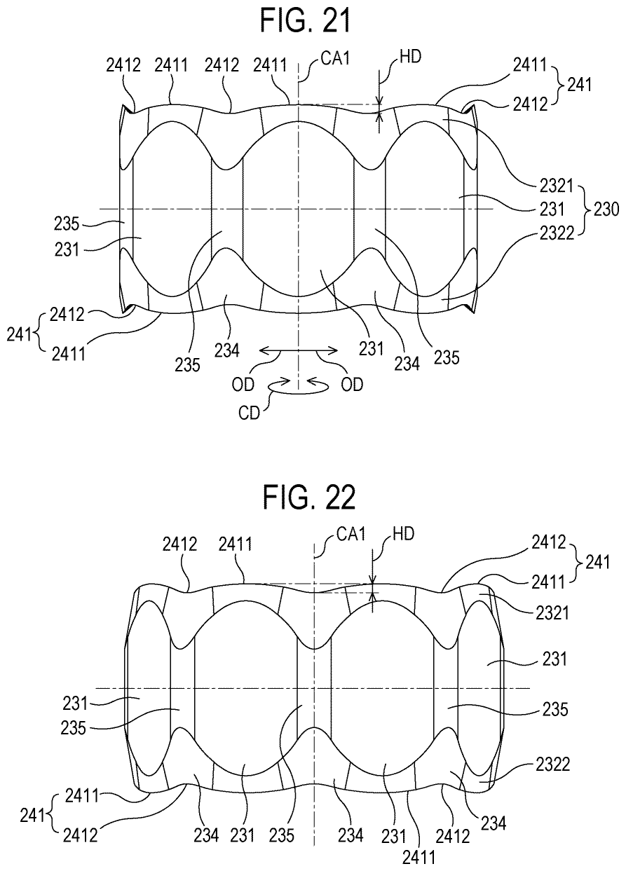

Reference is made to FIGS. 20 to 22. FIG. 20 is a plan view showing a cutting insert according to one embodiment. FIG. 21 is a side view of the cutting insert shown in FIG. 20, which is viewed from a seating side surface of a peripheral side surface. FIG. 22 is a side view of the cutting insert shown in FIG. 20, which is viewed in a diagonal direction of the cutting insert.

When the cutting insert is viewed from the plan view, the cutting insert forms a regular octagonal contour shape. The peripheral side surface 230 forms a regular octagonal peripheral contour line having eight round corners. The peripheral side surface 230 includes eight seating side surfaces 231, and each of the seating side surfaces is spaced apart from the first circular arc portion 2411 of the first cutting edge 2401 (or the second cutting edge) in the radially outward direction OD of the first central axis CA1. The seating side surfaces 231 neighboring in the circumferential direction CD are disposed so as to form the included angel AI of 135 degrees with respect to the first central axis CA1. The peripheral side surface 230 includes eight seating side surfaces and eight corner portions 234, thereby providing sixteen reference corners to the cutting insert.

Each of the first cutting edge 2401 and the second cutting edge includes eight partial cutting edges 241. Each of the partial cutting edges 241 has the central angle of 45 degrees with respect to the first central axis CA1. The central angle AC1 of the sector area including the first circular arc portion 2411, and the central angle AC2 of the sector area including the second circular arc portion 2412 may be 22.5 degrees. When the cutting insert is viewed from the side view, the first circular arc portion 2411 is formed so as to be curved convexly, and the second circular arc portion 2412 is formed so as to be curved concavely. In each partial cutting edge formed in a wavy shape, the first circular arc portion 2411 and the second circular arc portion 2412 have the height difference HD along the first central axis CA1.

The first diameter of the first imaginary circle inscribed in the first circular arc portions is less than the second diameter of the second imaginary circle inscribed in the seating side surfaces. The first curvature of the first circular arc portion 2411 is greater than the first curvature of the first circular arc portion shown in FIG. 17, and the second curvature of the second circular arc portion 2412 is greater than the second curvature of the second circular arc portion shown in FIG. 17. The edge distance ED1 between the midpoints of two first circular arc portions 2411 located opposite to each other with reference to the first central axis CA1 is shorter than the second edge distance ED2 between the midpoints of two second circular arc portions 2412 located opposite to each other with reference to the first central axis CA1. By way of example, the second edge distance ED2 may be 1.006 to 1.05 times longer than the first edge distance ED1. The second circular arc portions 2412 located opposite to each other with reference to the first central axis CA1 are disposed in the diagonal direction of the cutting insert (e.g., a direction passing through two corners located straight opposite to each other with reference to the first central axis in the regular octagonal contour shape).

The cutting insert is rotated by 45 degrees and can be remounted to the insert pocket. The insert pocket of the cutting tool, which holds the cutting insert shown in FIG. 20, may include two or more side walls, which two or more seating side surfaces 231 are contacted to and seated on, respectively. Further, the bottom wall of the insert pocket is inclined with respect to the rotation axis of the cutting tool at a seating angle less than the seating angle of the bottom wall of the insert pocket holding the cutting insert shown in FIG. 17.

The cutting inserts according to the above-described embodiments have the identical first and second end surfaces, and thus can be coupled to the cutting tool as a double-sided cutting insert. By way of other example, the cutting insert may be configured as a single-sided cutting insert. Where the cutting insert may be configured as a single-sided cutting insert, one of the first end surface and the second end surface may include a flat surface, and only one of the first cutting edge and the second cutting edge may be disposed at the intersection between the end surface and the peripheral side surface. Further, the peripheral side surface may include the above-described seating side surfaces, and only one of the first and second clearance side surfaces may be disposed between the cutting edge and the seating side surfaces.

The technical idea of the present disclosure has been described heretofore with reference to some embodiments and examples shown in the accompanying drawings. However, it is to be understood that various substitutions, modifications, and alterations may be made without departing from the technical idea and scope of the present disclosure that can be understood by those of ordinary skill in the technical field to which the present disclosure pertains. Further, it is to be understood that such substitutions, modifications, and alterations fall within the scope of the appended claims.

What is claimed is:

1. A double-sided cutting insert configured to be mounted to an insert pocket of a cutting tool rotated about a rotation axis, comprising:
a through bore perforated in a first central axis;
first and second end surfaces located opposite to each other in the first central axis;
a peripheral side surface disposed between the first and second end surfaces and including a plurality of seating side surfaces configured to be seated on the insert pocket and disposed at an equal interval in a circumferential direction of the first central axis; and
first and second cutting edges disposed at an intersection between the first end surface and the peripheral side surface and at an intersection between the second end surface and the peripheral side surface, respectively, each of the first and second cutting edges including a plurality of partial cutting edges connected one after another in the circumferential direction and curved convexly when the cutting insert is viewed from a plan view,
wherein each of the plurality of partial cutting edges includes a first circular arc portion curved convexly when the cutting insert is viewed from a side view, and a second circular arc portion extending from the first circular arc portion and curved concavely when the cutting insert is viewed from the side view,
wherein, when the cutting insert is viewed from the plan view, two second circular arc portions located opposite to each other with reference to the first central axis are disposed in a diagonal direction of the cutting insert, and
wherein each of the plurality of seating side surfaces is spaced apart from the first circular arc portion in a radially outward direction of the first central axis, and is disposed so as to be perpendicular to an imaginary line, which passes through the first central axis and a midpoint of the first circular arc portion and is orthogonal to the first central axis when the cutting insert is viewed from the side view.

2. The cutting insert of claim 1, wherein the first and second end surfaces are configured to be seated on the insert pocket in a state of being inclined with respect to the rotation axis of the cutting tool such that the first circular arc portion and the second circular arc portion form a cutting trajectory becoming a portion of a perfect circle.

3. The cutting insert of claim 1, wherein the peripheral side surface and the first and second cutting edges are disposed such that a first edge distance between midpoints of two first circular arc portions located opposite to each other with reference to the first central axis is shorter than a second edge distance between midpoints of two second circular arc portions located opposite to each other with reference to the first central axis.

4. The cutting insert of claim 3, wherein each of the plurality of partial cutting edges has a central angle of 90 degrees, 60 degrees or 45 degrees with respect to the first central axis, and
wherein the second edge distance is 1.02 to 1.2 times, 1.01 to 1.09 times or 1.006 to 1.05 times longer than the first edge distance.

5. The cutting insert of claim 1, wherein when the cutting insert is viewed from the plan view, the peripheral side surface forms a peripheral contour line having corners equal to the number of the plurality of seating side surfaces, and the plurality of seating side surfaces form a straight line becoming a portion of the peripheral contour line.

6. The cutting insert of claim 1, wherein two seating side surfaces neighboring in the circumferential direction among the plurality of seating side surfaces are disposed so as to form an included angle of 90 degrees, 120 degrees or 135 degrees with respect to the first central axis.

7. The cutting insert of claim 6, wherein the cutting insert is configured to be rotated by 90 degrees, 60 degrees or 45 degrees so as to be remounted to the insert pocket.

8. The cutting insert of claim 1, wherein when the cutting insert is viewed from the plan view, the peripheral side surface and the first and second cutting edges are disposed such that a diameter of a first imaginary circle inscribed in the first circular arc portion of each of the plurality of partial cutting edges is less than a diameter of a second imaginary circle inscribed in the plurality of seating side surfaces, and
wherein, when the cutting insert is viewed from the plan view, the first circular arc portion is curved at a first curvature and the second circular arc portion is curved at a second curvature greater than the first curvature.

9. The cutting insert of claim 8, wherein each of the plurality of partial cutting edges is formed such that the first curvature of the first circular arc portion is less than a curvature of the first imaginary circle and the second curvature of the second circular arc portion is greater than the curvature of the first imaginary circle.

10. The cutting insert of claim 8, wherein each of the plurality of partial cutting edges is formed such that a radius of curvature of the first circular arc portion is 1.1 to 2.5 times greater than a radius of the first imaginary circle.

11. The cutting insert of claim 1, wherein, when the cutting insert is viewed from the plan view, the first circular arc portion is curved at a first curvature and the second circular arc portion is curved at a second curvature greater than the first curvature, and
wherein, when the cutting insert is viewed from the side view, the midpoint of the first circular arc portion and a midpoint of the second circular arc portion have a height difference measured along the first central axis.

12. The cutting insert of claim 11, wherein, when the cutting insert is viewed from the side view, the first circular arc portion and the second circular arc portion form a wavy shape having a width equivalent to the height difference.

13. The cutting insert of claim 11, wherein, when the cutting insert is viewed from the plan view, an entirety of the first circular arc portion and a portion of the second circular arc portion are formed within a sector area that is centered on the first central axis and is defined between both ends of one of the plurality of seating side surfaces.

14. The cutting insert of claim 1, wherein the peripheral side surface includes first and second clearance side surfaces formed identically and disposed between the first cutting edge and the plurality of seating side surfaces and between the second cutting edge and the plurality of seating side surfaces, respectively.

15. The cutting insert of claim 14, wherein the first clearance side surface is inclined at an obtuse angle with respect to a portion of the first end surface, and wherein the second clearance side surface is inclined at an obtuse angle with respect to a portion of the second end surface.

16. The cutting insert of claim 14, wherein each of the plurality of seating side surfaces is divided from the first clearance side surface and the second clearance side surface by an intersection formed in a curved line.

17. The cutting insert of claim 1, wherein the first end surface includes a seating end surface surrounding the through bore in the circumferential direction and configured to be seated on the insert pocket, and a rake end surface extending in the circumferential direction between the seating end surface and first cutting edge, and
wherein the second end surface is formed identically to the first end surface.

18. The cutting insert of claim 17, wherein the seating end surface is configured to be seated on the insert pocket in a state of being inclined at an angle of equal to and more than 15 degrees to equal to and less than 30 degrees with respect to the rotation axis of the cutting tool.

19. A cutting tool rotated about a rotation axis, comprising:
a double-sided cutting insert;
a shank having a plurality of insert pockets configured such that the cutting insert is mounted thereto; and
a clamp screw configured to fix the cutting insert to one of the plurality of insert pockets,
wherein the cutting insert comprises:
a through bore perforated in a first central axis;
first and second end surfaces formed identically and located opposite to each other in the first central axis;
a peripheral side surface disposed between the first and second end surfaces and including a plurality of seating side surfaces disposed at an equal interval in a circumferential direction of the first central axis; and
first and second cutting edges formed identically and disposed at an intersection between the first end surface and the peripheral side surface and at an intersection between the second end surface and the peripheral side surface, respectively, each of the first and second cutting edges including a plurality of partial cutting edges connected one after another in the circumferential direction and curved convexly when the cutting insert is viewed from a plan view,
wherein each of the plurality of partial cutting edges includes a first circular arc portion curved convexly when the cutting insert is viewed from a side view, and a second circular arc portion extending from the first circular arc portion and curved concavely when the cutting insert is viewed from the side view,
wherein, when the cutting insert is viewed from the plan view, two second circular arc portions located opposite to each other with reference to the first central axis are disposed in a diagonal direction of the cutting insert,
wherein each of the plurality of seating side surfaces is spaced apart from the first circular arc portion in a radially outward direction of the first central axis, and is disposed so as to be perpendicular to an imaginary line, which passes through the first central axis and a midpoint of the first circular arc portion and is orthogonal to the first central axis when the cutting insert is viewed from the side view,
wherein each of the plurality of insert pockets includes:
a bottom wall positioned in the rotation direction of the cutting tool and having a threaded bore to which the clamp screw is fastened, wherein one of the first and second end surfaces is seated on the bottom wall; and
at least two side walls on which at least two seating side surfaces among the plurality of seating side surfaces are seated respectively, and
wherein the bottom wall is inclined with respect to the rotation direction and is contacted to one of the first and second end surfaces such that the first circular arc portion and the second circular arc portion form a cutting trajectory becoming a portion of a perfect circle.

20. The cutting tool of claim 19, wherein, when the cutting tool is viewed from a side view, the bottom wall is inclined at an angle of equal to and more than 15 degrees to equal to and less than 30 degrees with respect to the rotation axis.
